(19) United States
(12) Patent Application Publication
(10) Pub. No.: US 2025/0204721 A1
(43) Pub. Date: Jun. 26, 2025

(54) TRAVEL-SAFE COFFEE WARMER

(71) Applicant: Horst Friedrich Kruse, Las Vegas, NV (US)

(72) Inventor: Horst Friedrich Kruse, Las Vegas, NV (US)

(21) Appl. No.: 18/988,508

(22) Filed: Dec. 19, 2024

Related U.S. Application Data
(60) Provisional application No. 63/612,822, filed on Dec. 20, 2023.

(51) Int. Cl. A47J 36/24

(52) U.S. Cl. CPC A47J 36/2483

(57) ABSTRACT

The present invention is a portable warming device designed to accept commonly found paper cups with recessed bottoms. The present invention comprises a base, a pedestal, a disc, a 5-volt USB extension cord, and heat resistant foam. The present invention is designed to be a portable travel accessory that is self-contained with no moving parts or external plugins or addons. The height of the pedestal is ¾ in. The height of the base is ¼ in with a 2¾ in wide diameter. The present invention will be presented in an appropriate travel box. The user may simply take the present invention out-of-the-box; position the present invention into a car cupholder with said base side down; place a coffee cup onto said disc and said pedestal surface; then attach said USB extension cord to power. The present invention will heat to an optimum temperature between 135 and 150 degrees Fahrenheit.

### FIELD OF THE INVENTION

The present invention relates generally to warming devices and hot plates. Particularly, the present invention is a portable warming device designed to accept commonly found paper cups with recessed bottoms. The present invention comprises a base, a pedestal, a disc, a 5-volt USB extension cord, and heat resistant foam.

### BACKGROUND OF THE INVENTION

Vendors and drive through establishments commonly use paper cups with ¼ in to ½ in recessed bottoms. Due to their shape, these cups and the liquid contained within these cups cannot be kept warm on a typical flat hot plate. There is no available option for a compatible hot plate device that can fit portably within a vehicle's cupholder.

An objective of the present invention is to provide a device that can portably warm liquids held within commonly used paper cups with recessed bottoms by placing the cup onto the heating element on a pedestal and contacting the entire bottom of the paper cup. The pedestal of the present invention is sized to accept any size cup, whether small, medium, or large from every manufacturer. The optimum temperature for drinking is between 135 to 150 degrees Fahrenheit for maximum flavor. The heating element of the present invention is engineered to retain that temperature when plugging into a USB outlet. The present invention is designed to be powered through a USB outlet which can be commonly found within modern vehicles, computers, charger plug adapters. A plurality of lengths of USB extension cords allows users to place the present invention in different positions. While intended for use in a car cupholder, the present invention can be used on a flat surface or desktop.

### SUMMARY OF THE INVENTION

The present invention is a portable warming device designed to accept commonly found paper cups with recessed bottoms. The present invention is intended to heat liquid between 135 to 150 degrees Fahrenheit for consumption. The present invention comprises a base, a pedestal, a disc, a 5-volt USB extension cord, and heat resistant foam.

The present invention is designed to be a portable travel accessory that is self-contained with no moving parts or external plugins or addons. The height of the pedestal is ¾ in. The height of the base is ¼ in with a 2¾ in wide diameter. The present invention will be presented in an appropriate travel box. The user may simply take the present invention out-of-the-box; position the present invention into a car cupholder with said base side down; place a coffee cup onto said disc and said pedestal surface; then attach said USB extension cord to power. The present invention will heat liquid to an optimum temperature between 135 and 150 degrees Fahrenheit. A user can place a paper cup with a ¼ in to ½ in recessed bottom onto said disc and said pedestal. The paper cup will be warmed for the length of the user's drive. The present invention can also be used for desk work to warm coffee or other liquids. The user may lift the device out of the car cupholder, place next to a work area, and plug the USB cord into a computer or charger plug adapter.

### BRIEF DESCRIPTION OF THE DRAWINGS

FIG. 1 is a top front right perspective view of the present invention.

FIG. 2 is a top front left perspective view of the present invention.

FIG. 3 is a front elevational view of the present invention.

FIG. 4 is a rear elevational view of the present invention.

FIG. 5 is a right elevational view of the present invention.

FIG. 6 is a left elevational view of the present invention.

FIG. 7 is a top plan view of the present invention.

FIG. 8 is a bottom plan view of the present invention.

FIG. 9 is a cross-sectional view of the present invention.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header. All illustrations of the drawings are for the purpose of describing selected versions of the present invention and are not intended to limit the scope of the present invention.

The present disclosure includes many aspects and features. Moreover, while many aspects and features relate to, and are described in the context of the disclosed use cases, embodiments of the present disclosure are not limited to use only in this context.

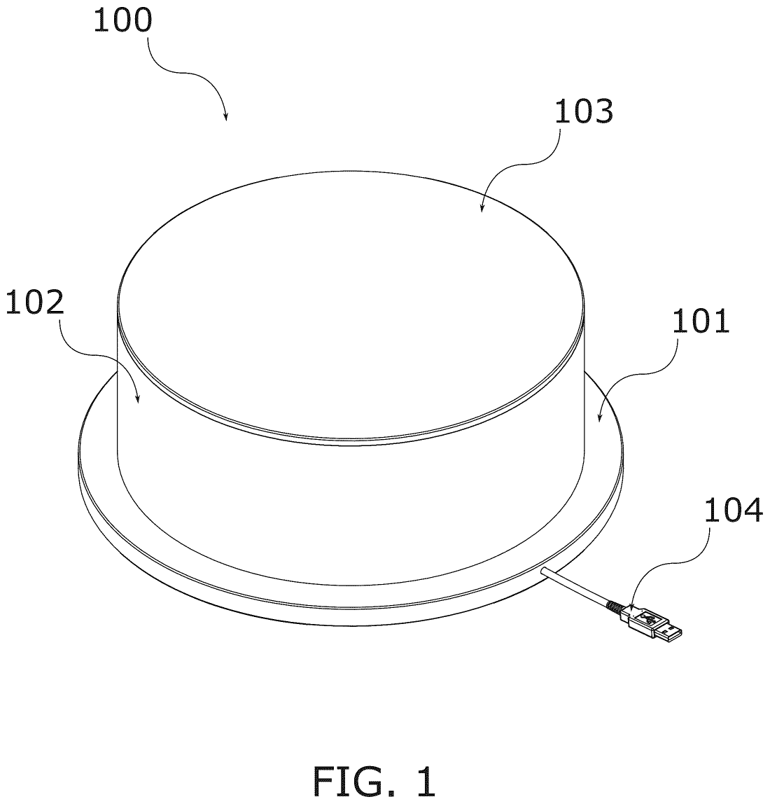

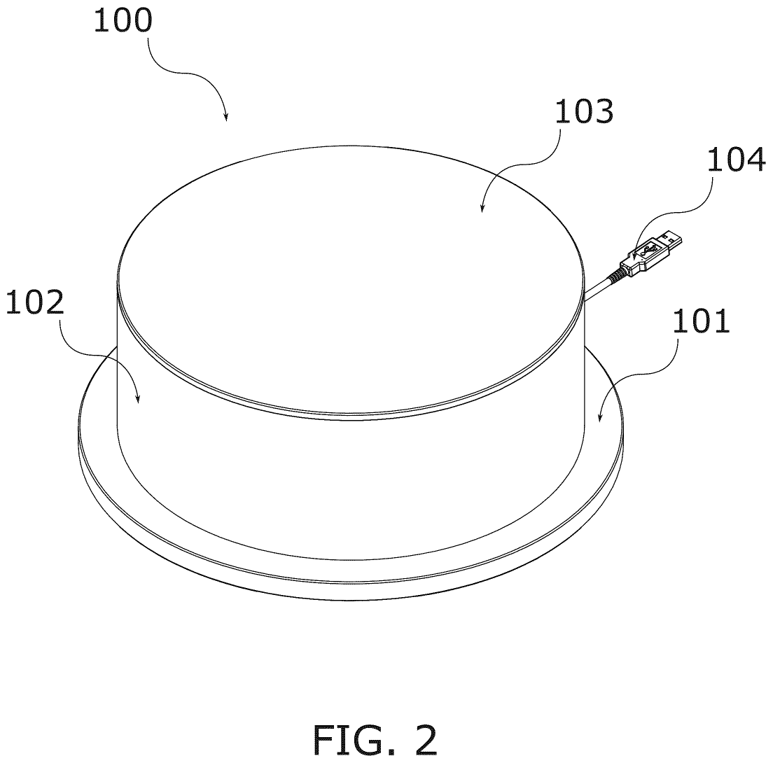

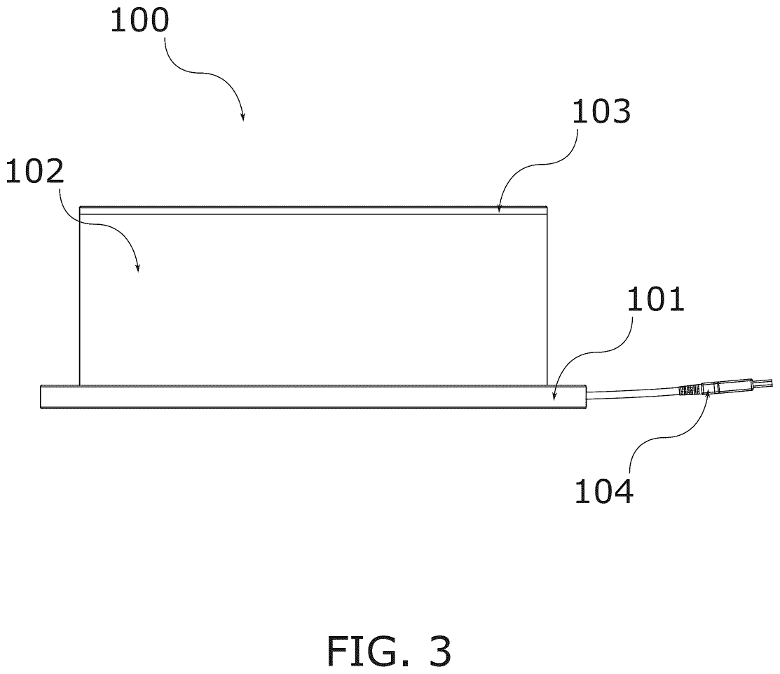

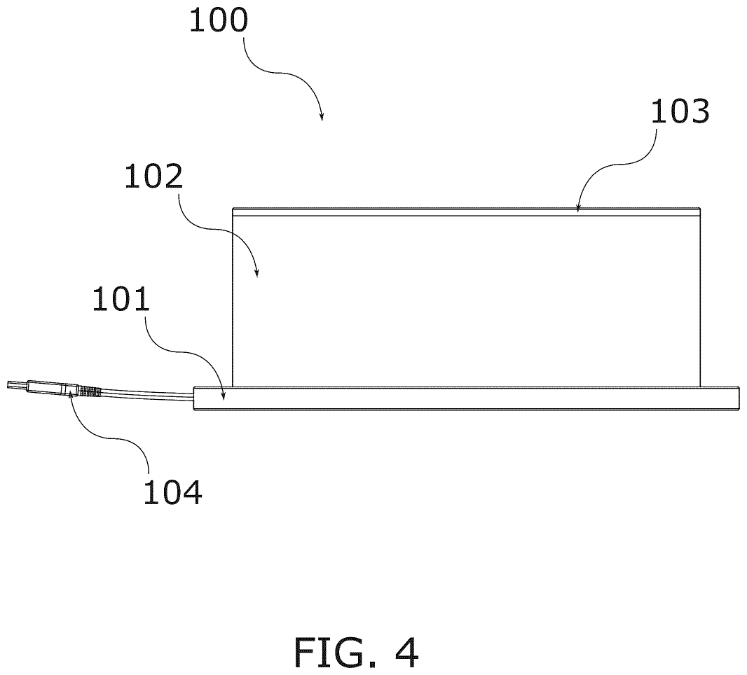

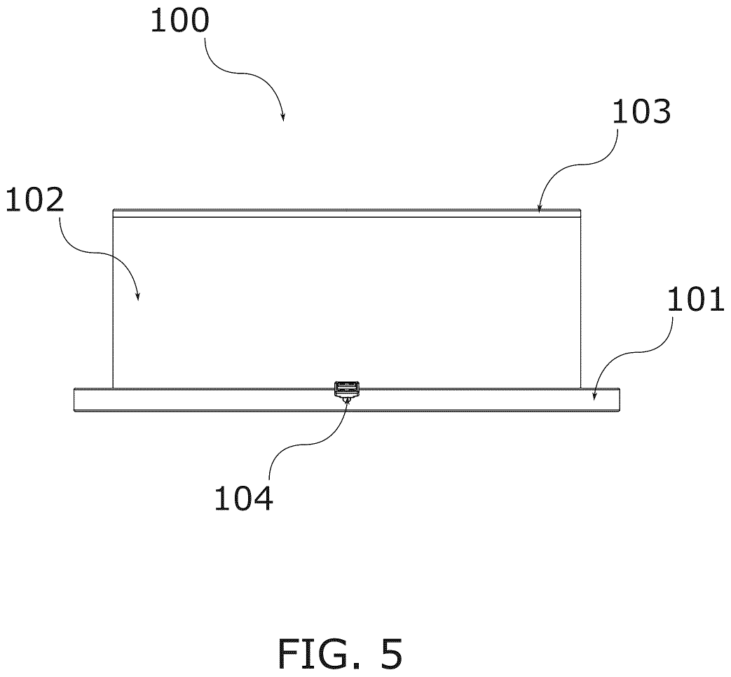

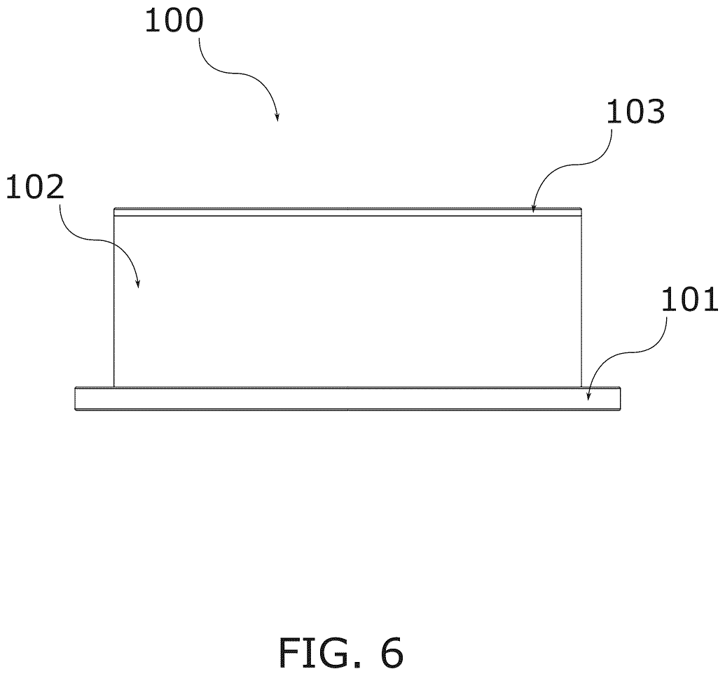

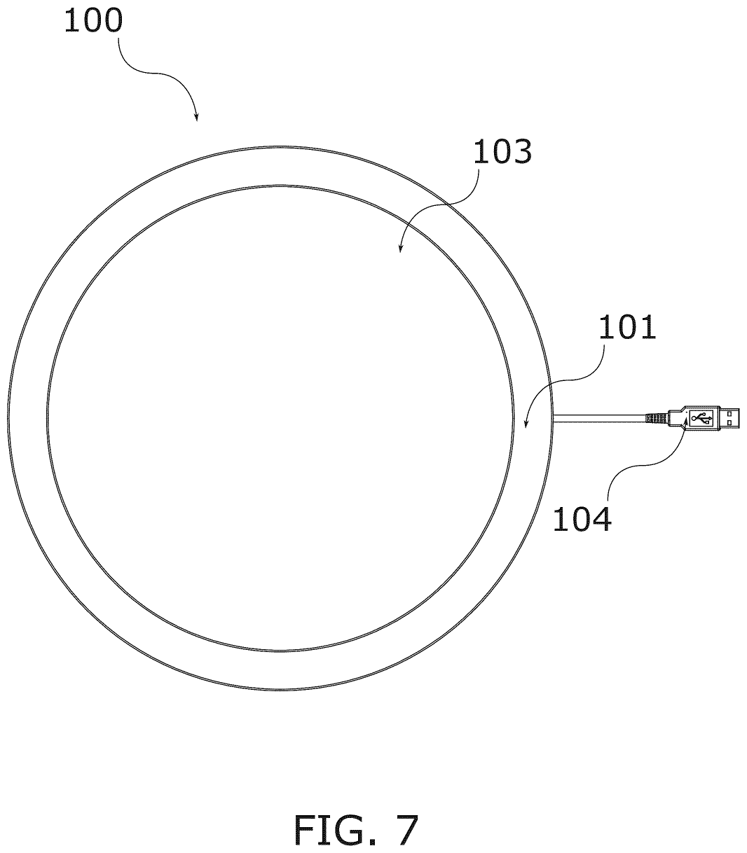

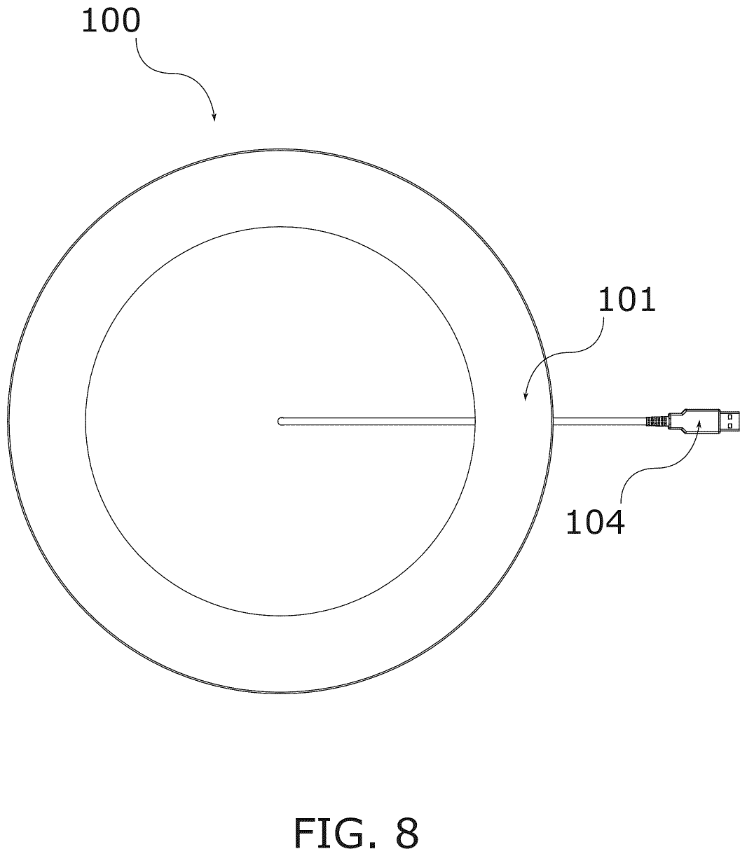

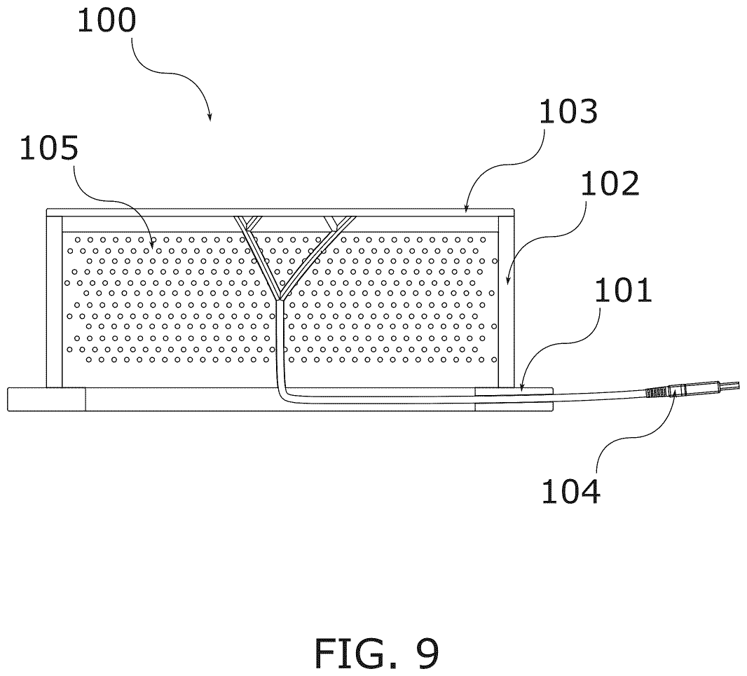

As shown in FIG. 1-9, the present invention comprises a base 101, a pedestal 102, a disc 103, a 5-volt USB extension cord 104, and heat resistant foam 105.

In the preferred embodiment of the present invention, said base 101 is 0.20 in thick. The height of said base 101 is ¼ in with a 2¾ in wide diameter. The overall height of the embodiment is 13/16 in tall and may be made using aluminum and plastic. The height of said pedestal 102 is ¾ in. The heat platform surface of said disc 103 is 2⅜ in below the console rest to prevent accidental contact with the user. In the preferred embodiment of the present invention, said pedestal 102 is made of polyurethane high heat deflection. In some embodiments, epoxy is used to connect various components of the present invention together. In the preferred embodiment of the present invention, said epoxy used is J-B Weld High Heat Resistant 550F epoxy.

In the preferred embodiment of the present invention, said heat resistant foam 105 is an internal ½ in thick heat resistant fiber insert. Said heat resistant foam 105 has a hole through the center for said USB extension cord 104 to contact with said disc 103.

In the preferred embodiment of the present invention, said disc 103 is a 0.020 in thick disc made of aluminum. Said USB extension cord 104 provides power to said disc 103 to heat the present invention to an optimum temperature between 135 to 150 degrees Fahrenheit. The maximum temperature of the present invention should not exceed 175 degrees Fahrenheit.

In the preferred embodiment of the present invention, the voltage DC-OV consumption of the present invention is 5 W. Said USB extension cord 104 is permanently attached to said disc 103 by separated wires to create a circuit in the central area through a middle fiber hole of said heat resistant foam 105. Said USB extension cord 104 runs through said base 101 to prevent snagging. Said USB extension cord 104 is locked in place to allow for a smooth, flat surface on the bottom of said base 101 when using the present invention for a flat surface area, such as a desk, table, or computer work area. Many embodiments of the present invention exist with varying lengths of said USB extension cord 104.

The user may simply take the present invention out-of-the-box; position the present invention into a car cupholder with said base 101 side down; place a coffee cup onto said disc 103 and said pedestal 102 surface; then attach said USB extension cord 104 to power. The present invention will heat to an optimum temperature between 135 and 150 degrees Fahrenheit. A user can place a paper cup with a ¼ in to ½ in recessed bottom onto said disc 103 and said pedestal 103. The paper cup will be warmed for the length of the user's drive. Alternatively, the present invention can also be used for desk work to warm coffee or other liquids. The user may lift the device out of the car cupholder, place next to a work area, and plug said USB extension cord 104 into a computer or other charger plug adapter.

Although the invention has been explained in relation to its preferred embodiment, it is to be understood that many other possible modifications and variations can be made without departing from the spirit and scope of the invention.

What is claimed is:

1. A device comprising:
a base;
a pedestal;
a disc;
a power cord;
wherein the size of said disc and said pedestal fits into the bottom of cups with ¼ in to ½ in recessed bottoms.

2. The device of claim 1, further comprising:
heat resistant foam.

3. The device of claim 2:
wherein said heat resistant foam has a through hole where said power cord connects to said disc.

4. The device of claim 1:
wherein said device is capable of heating liquid to a temperature between 135 to 150 degrees Fahrenheit.

5. The device of claim 4:
wherein said device requires no more than 5 W to heat said disc.

6. The device of claim 1:
wherein said power cord is a 5-volt USB extension cord.

7. The device of claim 1:
wherein said base, said pedestal, and said disc are connected by epoxy.

8. The device of claim 1:
wherein said base is a flat surface.

9. A device comprising:
a base;
a pedestal;
a disc;
a power cord;
heat resistant foam;
wherein the size of said disc and said pedestal fits into the bottom of cups with ¼ in to ½ in recessed bottoms.

10. The device of claim 9:
wherein said heat resistant foam has a through hole where said power cord connects to said disc.

11. The device of claim 9:
wherein said device is capable of heating liquid to a temperature between 135 to 150 degrees Fahrenheit.

12. The device of claim 11:
wherein said device requires no more than 5 W to heat said disc.

13. The device of claim 9:
wherein said power cord is a 5-volt USB extension cord.

14. The device of claim 9:
wherein said base, said pedestal, and said disc are connected by epoxy.

15. The device of claim 9:
wherein said base is a flat surface.

16. A device comprising:
a base;
a pedestal;
a disc;
a power cord;
heat resistant foam;
wherein the size of said disc and said pedestal fits into the bottom of cups with ¼ in to ½ in recessed bottoms;
wherein said heat resistant foam has a through hole where said power cord connects to said disc; and
wherein said device is capable of heating liquid to a temperature between 135 to 150 degrees Fahrenheit.

17. The device of claim 16:
wherein said device requires no more than 5 W to heat said disc.

18. The device of claim 16:
wherein said power cord is a 5-volt USB extension cord.

19. The device of claim 16:
wherein said base, said pedestal, and said disc are connected by epoxy.

20. The device of claim 16:
wherein said base is a flat surface.
